(19) United States
(12) Patent Application Publication
(10) Pub. No.: US 2021/0204093 A1
(43) Pub. Date: Jul. 1, 2021

(54) APPARATUS, SYSTEM AND METHOD OF WIRELESS COMMUNICATION OVER AN INDOOR-ONLY WIRELESS COMMUNICATION CHANNEL

(71) Applicant: INTEL CORPORATION, Santa Clara, CA (US)

(72) Inventors: Wilfrid D'Angelo, Mougins (FR); Ehud Reshef, Qiryat Tivon (IL); Nir Balaban, Kfar Netter (IL); Leor Rom, Haifa (IL)

(73) Assignee: INTEL CORPORATION, Santa Clara, CA (US)

(21) Appl. No.: 16/727,298

(22) Filed: Dec. 26, 2019

(51) Int. Cl. H04W 4/029; H04W 4/33; H04W 8/22; H04W 4/021

(52) U.S. Cl. CPC H04W 4/029; H04W 4/33; H04W 84/12; H04W 4/021; H04W 8/22

(57) ABSTRACT

Some demonstrative embodiments may include an apparatus including logic and circuitry configured to cause a mobile device to disable wireless communication of the mobile device over one or more indoor-only wireless communication channels according to an indoor regulatory constraint; determine whether the mobile device is located indoors or outdoors based on sensor information from a sensor of the mobile device; based on a determination that the mobile device is located indoors, enable the mobile device to communicate as a Wireless Local Area Network (WLAN) supervising device over an indoor-only wireless communication channel of the one or more indoor-only wireless communication channels.

### TECHNICAL FIELD

Embodiments described herein generally relate to wireless communication over an indoor-only wireless communication channel.

### BACKGROUND

A wireless communication device may be configured to communicate over a plurality of wireless communication channels.

One or more channels of the plurality of wireless communication channels may include indoor-only wireless communication channels, which may be allowed for communication only for indoor use, e.g., due to regulatory requirements.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some exemplary embodiments.

FIG. 2 is a schematic flow-chart illustration of a method of wireless communication over an indoor-only wireless communication channel, in accordance with some exemplary embodiments.

FIG. 3 is a schematic flow-chart illustration of a method of wireless communication over an indoor-only wireless communication channel, in accordance with some exemplary embodiments.

FIG. 4 is a schematic illustration of a product of manufacture, in accordance with some exemplary embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a sensor device, an Internet of Things (IoT) device, a wearable device, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing IEEE 802.11 standards (including IEEE 802.11-2016 (IEEE 802.11-2016, IEEE Standard for Information technology—Telecommunications and information exchange between systems Local and metropolitan area networks—Specific requirements Part 11: Wireless LAN Medium Access Control (MAC) and Physical Layer (PHY) Specifications, Dec. 7, 2016)), and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), Spatial Divisional Multiple Access (SDMA), Time-Division Multiplexing (TDM), Time-Division Multiple Access (TDMA), Multi-User MIMO (MU-MIMO), General Packet Radio Service (GPRS), extended GPRS (EGPRS), Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative embodiments may be used in conjunction with a WLAN, e.g., a WiFi network. Other embodiments may be used in conjunction with any other suitable wireless communication network, for example, a wireless area network, a “piconet”, a WPAN, a WVAN and the like.

Some demonstrative embodiments may be used in conjunction with a wireless communication network communicating over a frequency band of 2.4 GHz, 5 GHz, and/or 6-7 GHz. However, other embodiments may be implemented utilizing any other suitable wireless communication frequency bands, for example, an Extremely High Frequency (EHF) band (the millimeter wave (mmWave) frequency band), e.g., a frequency band within the frequency band of between 20 GHz and 300 GHz, a WLAN frequency band, a WPAN frequency band, and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

Some demonstrative embodiments may be implemented for “peer to peer (PTP) communication”, which may relate to device-to-device communication over a wireless link (“peer-to-peer link”) between devices. The PTP communication may include, for example, a Wi-Fi Direct (WFD) communication, e.g., a WFD Peer to Peer (P2P) communication, wireless communication over a direct link within a Quality of Service (QoS) basic service set (BSS), a tunneled direct-link setup (TDLS) link, a STA-to-STA communication in an independent basic service set (IBSS), a Wi-Fi Aware communication, or the like. Other embodiments may be implemented for any other additional or alternative communication scheme and/or technology.

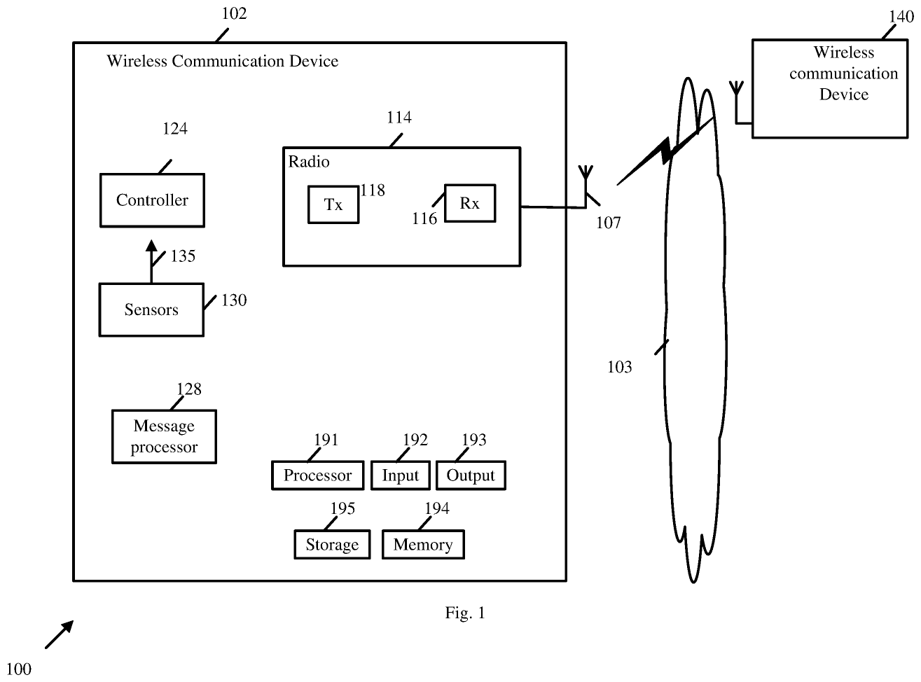

Reference is now made to FIG. 1, which schematically illustrates a block diagram of a system 100, in accordance with some exemplary embodiments.

As shown in FIG. 1, in some demonstrative embodiments, system 100 may include a wireless communication network including one or more wireless communication devices, e.g., a wireless communication device 102, and/or at least one wireless communication device 140.

In some demonstrative embodiments, wireless communication device 102 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative embodiments, device 102 and/or device 140 may include, operate as, and/or perform the functionality of one or more STAs. For example, device 102 may include at least one STA, and/or device 140 may include at least one STA.

In some demonstrative embodiments, device 102 and/or device 140 may include, operate as, and/or perform the functionality of one or more WLAN STAs.

In some demonstrative embodiments, device 102 and/or device 140 may include, operate as, and/or perform the functionality of one or more Wi-Fi STAs.

In one example, a station (STA) may include a logical entity that is a singly addressable instance of a medium access control (MAC) and physical layer (PHY) interface to the wireless medium (WM). The STA may perform any other additional or alternative functionality.

In some demonstrative embodiments, devices 102 and/or 140 may include a non-AP STA or an access point (AP) STA.

In one example, an AP may include an entity that contains a station (STA), e.g., one STA, and provides access to distribution services, via the wireless medium (WM) for associated STAs. The AP may perform any other additional or alternative functionality.

In one example, a non-AP STA may include a STA that is not contained within an AP. The non-AP STA may perform any other additional or alternative functionality.

In some demonstrative embodiments, device 102 and/or device 140 may include, operate as, and/or perform the functionality of, any other devices and/or STAs.

In some demonstrative embodiments, device 102 may include, for example, one or more of a processor 191, an input unit 192, an output unit 193, a memory unit 194, and/or a storage unit 195. Device 102 may optionally include other suitable hardware components and/or software components. In some demonstrative embodiments, some or all of the components of device 102 may be enclosed in a common housing or packaging, and may be interconnected or operably associated using one or more wired or wireless links. In other embodiments, components of device 102 may be distributed among multiple or separate devices.

In some demonstrative embodiments, processor 191 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of device 102 and/or of one or more suitable applications.

In some demonstrative embodiments, input unit 192 may include, for example, a keyboard, a keypad, a mouse, a touch-screen, a touch-pad, a track-ball, a stylus, a microphone, or other suitable pointing device or input device. Output unit 193 includes, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative embodiments, memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 includes, for example, a hard disk drive, a Solid State Drive (SSD), a floppy disk drive, a Compact Disk (CD) drive, a CD-ROM drive, a DVD drive, or other suitable removable or non-removable storage units. Memory unit 194 and/or storage unit 195, for example, may store data processed by device 102.

In some demonstrative embodiments, wireless communication device 102 may be capable of communicating content, data, information and/or signals via a wireless medium (WM) 103.

In some demonstrative embodiments, wireless medium 103 may include, for example, a radio channel, a channel, a cellular channel, a Global Navigation Satellite System (GNSS) Channel, an RF channel, a WiFi channel, an IR channel, and the like.

In some demonstrative embodiments, wireless communication medium 103 may include a 2.4 GHz frequency band, and/or one or more other wireless communication frequency bands, for example, a 5 GHz frequency band, a 6-7 GHz frequency band, a millimeterWave (mmWave) frequency band, e.g., a 60 GHz frequency band, a Sub-1 GHz (S1G) band, and/or any other frequency band.

In some demonstrative embodiments, devices 102 and/or 140 may include one or more radios including circuitry and/or logic to perform wireless communication between devices 102, 140 and/or one or more other devices. For example, device 102 may include at least one radio 114.

In some demonstrative embodiments, radio 114 may include one or more wireless receivers (Rx) including circuitry and/or logic to receive wireless communication signals, RF signals, frames, blocks, transmission streams, packets, messages, data items, and/or data. For example, radio 114 may include at least one receiver 116.

In some demonstrative embodiments, radio 114 may include one or more wireless transmitters (Tx) including circuitry and/or logic to transmit wireless communication signals, RF signals, frames, blocks, transmission streams, packets, messages, data items, and/or data. For example, radio 114 may include at least one transmitter 118.

In some demonstrative embodiments, radio 114, transmitter 118, and/or receiver 116 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative embodiments, radio 114 may be configured to communicate over a 5 GHz band, a 6-7 GHz band, and/or any other band.

In some demonstrative embodiments, radio 114 may include, or may be associated with, one or more antennas 107.

In one example, device 102 may include a single antenna 107. In another example, device 102 may include two or more antennas 107.

Antennas 107 may include any type of antennas suitable for transmitting and/or receiving wireless communication signals, blocks, frames, transmission streams, packets, messages and/or data. For example, antennas 107 may include any suitable configuration, structure and/or arrangement of one or more antenna elements, components, units, assemblies and/or arrays. In some embodiments, antennas 107 may implement transmit and receive functionalities using separate transmit and receive antenna elements. In some embodiments, antennas 107 may implement transmit and receive functionalities using common and/or integrated transmit/receive elements.

In some demonstrative embodiments, device 102 may include a controller 124 configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, and/or one or more other devices, e.g., as described below.

In some demonstrative embodiments, controller 124 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controller 124. Additionally or alternatively, one or more functionalities of controller 124 may be implemented by logic, which may be executed by a machine and/or one or more processors, e.g., as described below.

In some demonstrative embodiments, at least part of the functionality of controller 124 may be implemented as part of one or more elements of radio 114.

In other embodiments, the functionality of controller 124 may be implemented as part of any other element of device 102.

In some demonstrative embodiments, device 102 may include a message processor 128 configured to generate, process and/or access one or more messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), e.g., a PHY Layer Convergence Procedure (PLCP) PDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative embodiments, message processor 128 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, BB circuitry and/or logic, a BB processor, a BB memory, AP circuitry and/or logic, an AP processor, an AP memory, and/or any other circuitry and/or logic, configured to perform the functionality of message processor 128, respectively. Additionally or alternatively, one or more functionalities of message processor 128 may be implemented by logic, which may be executed by a machine and/or one or more processors, e.g., as described below.

In some demonstrative embodiments, at least part of the functionality of message processor 128 may be implemented as part of radio 114.

In some demonstrative embodiments, at least part of the functionality of message processor 128 may be implemented as part of controller 124.

In other embodiments, the functionality of message processor 128 may be implemented as part of any other element of device 102.

In some demonstrative embodiments, at least part of the functionality of controller 124 and/or message processor 128 may be implemented by an integrated circuit, for example, a chip, e.g., a System on Chip (SoC). In one example, the chip or SoC may be configured to perform one or more functionalities of radio 114. For example, the chip or SoC may include one or more elements of controller 124, one or more elements of message processor 128, and/or one or more elements of radio 114. In one example, controller 124, message processor 128, and radio 114 may be implemented as part of the chip or SoC.

In other embodiments, controller 124, message processor 128 and/or radio 114 may be implemented by one or more additional or alternative elements of device 102.

In some demonstrative embodiments, device 102 and/or device 140 may include, operate as, perform the role of, and/or perform one or more functionalities of, one or more STAs.

In some demonstrative embodiments, device 102 and/or device 140 may form, or may communicate as part of, a wireless local area network (WLAN).

In some demonstrative embodiments, device 102 and/or device 140 may form, or may communicate as part of, a WiFi network.

In other embodiments, device 102 and/or device 140 may form, and/or communicate as part of, any other additional or alternative network.

In some demonstrative embodiments, device 102 may include, operate as, and/or perform one or more functionalities of, a Wireless Local Area Network (WLAN) supervising device, e.g., as described below.

In some demonstrative embodiments, a WLAN supervising device may include a device configured to initialize, form, control, manage, synchronize, and/or coordinate communication over a WLAN, for example, over a BSS, a P2P group and/or any other WLAN network.

In some demonstrative embodiments, device 102 may include, operate as, and/or perform one or more functionalities of, a Software Enabled AP (Soft AP), e.g., as described below.

In some demonstrative embodiments, a soft AP may include a STA, e.g., a non-AP STA, which is associated with an AP, and capable of communicating as an AP with one or more other STAs.

In some demonstrative embodiments, the soft AP may transmit traffic to and/or receive traffic from the AP, e.g., when acting as a STA.

In some demonstrative embodiments, the soft AP may transmit traffic to and/or receive traffic from one or more clients, e.g., other STAs that are associated with the soft AP, e.g., when acting as a soft AP.

In some demonstrative embodiments, device 102 may include, operate as, and/or perform one or more functionalities of, a Peer to Peer (P2P) Group Owner (GO), for example, in accordance with one or more IEEE standards.

In other embodiments, device 102 may include any other WLAN supervising device configured to control, manage, synchronize, and/or coordinate communication in a WLAN network.

In some demonstrative embodiments, some wireless communication devices, e.g., device 102, may be mobile and may move in and out of an indoor location, for example, compared to a source AP, which may be static and connected to a wired connection, e.g., an Ethernet connection, in the indoor location.

In some demonstrative embodiments, device 102 may be configured to communicate over a plurality of wireless communication channels.

In some demonstrative embodiments, the plurality of wireless communication channels may include one or more indoor-only wireless communication channels.

In some demonstrative embodiments, an indoor-only channel may include a wireless communication channel, which is restricted for indoor use only, e.g., according to one or more regulations and/or standards.

For example, one or more indoor-only channels may be defined in an unlicensed frequency band to be utilized only in an indoor location, e.g., according to Federal Communication Commission (FCC) regulations, European Telecommunications Standards Institute (ETSI) regulations, and/or any other regulations.

In some demonstrative embodiments, the indoor-only channel may include a channel in a frequency bandwidth of 5 GHz.

For example, one or more indoor-only channels may be defined in an Unlicensed National Information Infrastructure (UNIT) frequency band operating at a range of channels of 5150-5250 MHz (UNII1), and/or any other channels of the 5 GHz band, which may be restricted to indoor-only use.

In other embodiments, the indoor-only channel may include any other channel in any other frequency band, e.g., a 6-7 GHz band and/or any other band.

In other embodiments, the indoor-only channels may include any other channel in any other frequency bands, which may be restricted for indoor use only, e.g., according to any other regulations and/or rules.

In some demonstrative embodiments, communication in the one or more indoor-only channels may not be allowed outdoors, for example, in some unlicensed frequencies, for example, due to interference, which may be caused to incumbent services outdoors.

For example, vendors may create indoor products, which may be for indoor use only and/or may completely disable specific operation in the unlicensed frequencies outdoors, for example, if the products cannot determine whether their location is indoors or outdoors.

For example, regulatory rules may limit a number of possible wireless channels for STAs, e.g., between 4-8 20 MHz channels according to most regulatory rules, while most of the spectrum may be restricted to indoor usage.

In one example, wireless spectrum may be limited, and, accordingly, in many areas congestion and overlapping channels may reduce an efficiency of the network in many areas in a manner, which may cause degradation to user experience, e.g., increased latency, lower responsiveness, reduced transfer speed, and/or increased power consumption.

In some demonstrative embodiments, in some use cases and/or scenarios, there may be a technical need to increase the wireless spectrum for usage by a STA, e.g., the STA implemented by device 102, for example, to deliver an increased user experience, e.g., as described below.

In some demonstrative embodiments, using dedicated products for indoor use only, for example, by creating a dedicated HW version, e.g., using an NVM configuration, may increase cost and complexity, for example, to maintain multiple HW versions. In addition, in such a solution, vendors may be required to classify a device as indoor only, which may prevent usage of that device outdoors.

In some demonstrative embodiments, disabling usage of specific frequencies for wireless standalone operation may limit wireless communication, for example, to congested frequencies, which may result in degraded user experience.

In some demonstrative embodiments, a STA, e.g., a STA implemented by device 102, may be configured to dynamically detect indoor locations to allow the STA to initiate operations in a significantly larger wireless spectrum, which may provide an improved user experience to a user, e.g., as described below.

In some demonstrative embodiments, device 102 may be configured to support and/or implement an indoor detection scheme, which may include, for example, collecting, e.g., securely collecting, data on a surrounding environment; ensuring that device 102 is located indoors, e.g., based on the collected data; and applying regulatory rules for indoor operation, e.g., as described below.

In some demonstrative embodiments, the indoor detection scheme may be implemented by device 102 to allow operation of a STA on indoor-only wireless communication channels, for example, based on a geographic location of the STA, e.g., as described below.

In some demonstrative embodiments, the indoor detection scheme may be implemented by device 102 to allow a mobile/portable device, e.g., device 102, to operate in a larger portion of the frequency spectrum, for example, even without maintaining dedicated indoor HW, e.g., as described below.

In some demonstrative embodiments, the indoor detection scheme may be implemented by device 102 to allow device 102 to implement some use cases and/or scenarios, for example, as a WLAN supervising device, e.g., SoftAP, P2P GO, Miracast, Wireless docking and/or the like, in indoor locations, which may provide an improved user experience, e.g., as described below.

In some demonstrative embodiments, controller 124 may be configured to cause, trigger, and/or control the wireless communication station implemented by device 102 to disable wireless communication of device 102 over one or more indoor-only wireless communication channels, for example, according to an indoor regulatory constraint, e.g., as described below.

In some demonstrative embodiments, controller 124 may be configured to cause, trigger, and/or control the wireless communication station implemented by device 102 to determine whether device 102 is located indoors or outdoors based on sensor information 135 from a sensor 130 of device 102, e.g., as described below.

In some demonstrative embodiments, controller 124 may be configured to cause, trigger, and/or control the wireless communication station implemented by device 102 to, based on a determination that device 102 is located indoors, enable device 102 to communicate as a WLAN supervising device over an indoor-only wireless communication channel of the one or more indoor-only wireless communication channels, e.g., as described below.

In some demonstrative embodiments, the WLAN supervising device may include, for example, a SoftAP, or a P2P GO, e.g., as described below.

In other embodiments, the WLAN supervising device may include any other type of device configured to supervise, control, initiate, form, manage, coordinate, and/or synchronize communication over a WLAN network, e.g., a BSS, a P2P network, and/or any other network.

In some demonstrative embodiments, the sensor information 135 may include, for example, environment information of an environment of device 102, e.g., as described below.

In some demonstrative embodiments, device 102 may include one or more sensors 130.

In some demonstrative embodiments, sensors 130 may include ambient light sensor, e.g., as described below.

In some demonstrative embodiments, the sensor information 135 may include, for example, ambient light information from the ambient light sensor 130 of device 102, e.g., as described below.

In some demonstrative embodiments, controller 124 may be configured to cause, trigger, and/or control the wireless communication station implemented by device 102 to identify an ambient light spectrum, for example, based on the ambient light information from the ambient light sensor 130, and to determine whether device 102 is located indoors or outdoors based on the ambient light spectrum, e.g., as described below.

In some demonstrative embodiments, controller 124 may be configured to cause, trigger, and/or control the wireless communication station implemented by device 102 to determine that device 102 is located outdoors, for example, based on a determination that the ambient light spectrum corresponds to natural light, e.g., as described below.

In some demonstrative embodiments, controller 124 may be configured to cause, trigger, and/or control the wireless communication station implemented by device 102 to determine that device 102 is located indoors, for example, based on a determination that the ambient light spectrum corresponds to artificial light, e.g., as described below.

In some demonstrative embodiments, sensors 130 may include a location sensor 130, for example, a GPS sensor, an inertial sensor, and/or any other location sensor.

In some demonstrative embodiments, sensor information 135 may include, for example, location information from the location sensor 130 of device 102, e.g., as described below.

In some demonstrative embodiments, controller 124 may be configured to cause, trigger, and/or control the wireless communication station implemented by device 102 to determine the indoor-only wireless communication channel, for example, based on the location information from the location sensor 130, e.g., as described below.

In some demonstrative embodiments, sensors 130 may include a proximity sensor, e.g., as described below.

In some demonstrative embodiments, sensor information 135 may include, for example, proximity information from the proximity sensor of device 102.

In one example, controller 124 and/or device 102 may be configured to determine that device is located indoors, for example, based on a determination that the proximity information indicates proximity to one or more indoor devices and/or objects.

In some demonstrative embodiments, sensors 130 may include an acoustic sensor, e.g., as described below.

In one example, controller 124 and/or device 102 may be configured to determine that device is located indoors, for example, based on a determination that the acoustic information includes one or more echo signals returned from one or more objects in one or more predefined directions, e.g., from a top direction and/or one or more side directions.

In some demonstrative embodiments, sensor information 135 may include, for example, acoustic information from the acoustic sensor of device 102.

In some demonstrative embodiments, controller 124 may be configured to cause, trigger, and/or control the wireless communication station implemented by device 102 to determine the indoor-only wireless communication channel, for example, based on the acoustic information and/or the proximity information, e.g., as described below.

In other embodiments, sensor information 135 may include any other information, from any other additional or alternative type of sensors 130.

In some demonstrative embodiments, controller 124 may be configured to cause, trigger, and/or control the wireless communication station implemented by device 102 to determine whether device 102 is located indoors or outdoors, for example, based on wireless communication information from one or more wireless communications over a non-indoor wireless communication channel, e.g., as described below.

In some demonstrative embodiments, the wireless communication information may include, for example, channel estimation information corresponding to the non-indoor wireless communication channel.

In some demonstrative embodiments, the wireless communication information may include, for example, device information corresponding to one or more wireless communication devices communicating over the non-indoor wireless communication channel e.g., as described below.

In some demonstrative embodiments, device 102 may be configured to perform one or more operations, for example, when device 102 communicates as the WLAN supervising device over the indoor-only wireless communication channel, e.g., as described below.

In some demonstrative embodiments, controller 124 may be configured to cause, trigger, and/or control the wireless communication station implemented by device 102 to maintain a virtual geofence around device 102, for example, when enabling device 102 to communicate as the WLAN supervising device, e.g., as described below.

In some demonstrative embodiments, controller 124 may be configured to cause, trigger, and/or control the wireless communication station implemented by device 102 to, based on a detected crossing of the geofence by device 102, disable wireless communication of device 102 over the one or more indoor-only wireless communication channels, for example, according to the indoor regulatory constraint, e.g., as described below.

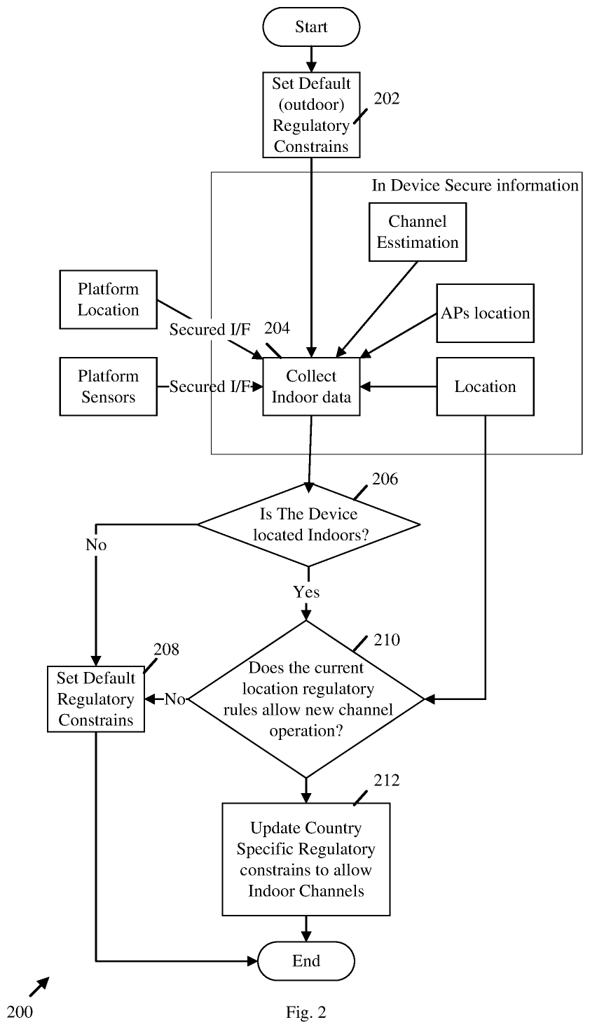

Reference is made to FIG. 2, which schematically illustrates a method of wireless communication over an indoor-only wireless communication channel, in accordance with some exemplary embodiments. For example, one or more operations of the method of FIG. 2 may be performed by one or more elements of a system, e.g., system 100 (FIG. 1), for example, one or more wireless devices, e.g., device 102 (FIG. 1), a controller, e.g., controller 124 (FIG. 1), a radio, e.g., radio 114 (FIG. 1), a receiver, e.g., receiver 116 (FIG. 1), and/or a message processor, e.g., message processor 128 (FIG. 1).

As indicated at block 202, the method may include setting default regulatory constraints in a wireless communication device, for example, to outdoor regulatory rules. For example, controller 124 (FIG. 1) and/or device 102 (FIG. 1) may disable the wireless communication over the indoor-only channels according to the regulatory rules, e.g., as described above.

In one example, device 102 (FIG. 1) may set its regulatory settings for outdoor usage, e.g., at initialization, for example, to disable indoor channels for wireless standalone operation, e.g. Wi-Fi standalone operation.

As indicated at block 204, the method may include collecting indoor data, for example, from one or more sensors. For example, controller 124 (FIG. 1) and/or device 102 (FIG. 1) may collect data from sensors 130 (FIG. 1), and/or any other sensors, e.g., as described above.

In one example, controller 124 (FIG. 1) and/or device 102 (FIG. 1) may collect the indoor data, e.g., periodically, for example, based on in-device secure capabilities. For example, controller 124 (FIG. 1) and/or device 102 (FIG. 1) may use capabilities of device 102 (FIG. 1) to collect data on indoor\outdoor location, for example, based on channel estimation of one or more wireless channels, surrounding APs and/or clients, distance to APs, distance and presence of obstacles, and/or the like.

In another example, controller 124 (FIG. 1) and/or device 102 (FIG. 1) may collect the indoor data, e.g., periodically, for example, based on information from platform sensors with a secure Interface (I/F), e.g., proximity sensors, light sensors, location sensors, and/or any other sensors 130 (FIG. 1).

As indicated at block 206, the method may include determining whether or not the wireless communication device is located indoors. For example, controller 124 (FIG. 1) and/or device 102 (FIG. 1) may determine if wireless communication device is located indoors based on the information from sensors 130 (FIG. 1), e.g., as described above.

In one example, controller 124 (FIG. 1) and/or device 102 (FIG. 1) may analyze the data from sensors 130 (FIG. 1), e.g., according to regulatory rules, and may conclude if device 102 (FIG. 1) is located outdoors, indoors, or if it is not possible to determine whether device 102 (FIG. 1) is located outdoors or indoors, e.g., as described below.

In one example, controller 124 (FIG. 1) and/or device 102 (FIG. 1) may determine whether or not device 102 (FIG. 1) is located indoors, for example, based on a location of device 102. For example, controller 124 (FIG. 1) and/or device 102 (FIG. 1) may determine that device 102 (FIG. 1) is located indoors, for example, if device 102 (FIG. 1) is located within a perimeter that is defined, for example, based on an external server query, as an indoor complex, house, office, mall and/or the like.

In another example, controller 124 (FIG. 1) and/or device 102 (FIG. 1) may determine whether or not the wireless communication device 102 (FIG. 1) is located indoors, for example, based on an environmental parameter, which may be significantly different between indoor and outdoor environments. For example, sensor 130 (FIG. 1) may include an ultra-violet (UV) sensor or any other light sensor configured to distinguish between natural and artificial light.

As indicated at block 208, the method may include setting default regulatory constraints, for example, if the wireless communication device is determined to be located outdoors. For example, controller 124 (FIG. 1) and/or device 102 (FIG. 1) may disable the wireless communication over the indoor only channels according to the regulatory constraints, for example, if device 102 (FIG. 1) is located outdoors, e.g., as described above.

In one example, controller 124 (FIG. 1) and/or device 102 (FIG. 1) may stay or switch to outdoor regulatory capabilities, for example, if the location of device 102 (FIG. 1) is undetermined or determined to be outdoors.

As indicated at block 210, the method may include determining whether or not regulatory rules of a current location allow operation over one or more indoor-only channels, for example, if the wireless communication device is located indoors. For example, controller 124 (FIG. 1) and/or device 102 (FIG. 1) may determine whether or not the regulatory rules of the current location allow operation over one or more indoor-only channels, for example, if the location of device 102 (FIG. 1) is determined to be indoors, e.g., as described above.

In one example, controller 124 (FIG. 1) and/or device 102 (FIG. 1) may switch to operate according to indoor regulatory capabilities, and may enable indoor channels for Wi-Fi standalone operation, e.g., WLAN supervising operation, for example, if a current location allows the use of these channels, for example, when the location of device 102 (FIG. 1) is determined to be indoors.

As indicated at block 212, the method may include updating current regulatory constraints, for example, to allow operations on the indoor-only channels. For example, controller 124 (FIG. 1) and/or device 102 (FIG. 1) may update the current regulatory constraints for operation of device 102 (FIG. 1), for example, to allow the operations of device 102 (FIG. 1) on the indoor-only channels, for example, as a WLAN supervising device, e.g., as described above.

In some demonstrative embodiments, controller 124 (FIG. 1) and/or device 102 (FIG. 1) may perform one or more, e.g., all, operations, of the method of FIG. 2, periodically, and/or based on movement detection. For example, controller 124 (FIG. 1) and/or device 102 (FIG. 1) may trigger the one or more operations of the method of FIG. 2, e.g., by switching back to a mode of disabling the operation on indoor-only channels as described above with reference to block 202, for example, based on an indication of movement of device 102 (FIG. 1) from the current location.

In some demonstrative embodiments, controller 124 (FIG. 1) and/or device 102 (FIG. 1) may maintain a geofence, e.g., a micro geofence, around a current location of device 102 (FIG. 1).

In some demonstrative embodiments, any movement beyond the geofence may reset the regulatory setting to the outdoor usage, e.g., according to block 202, and/or may trigger the one or more operations of the method of FIG. 2, for example, until a new cycle of indoor detection may be completed.

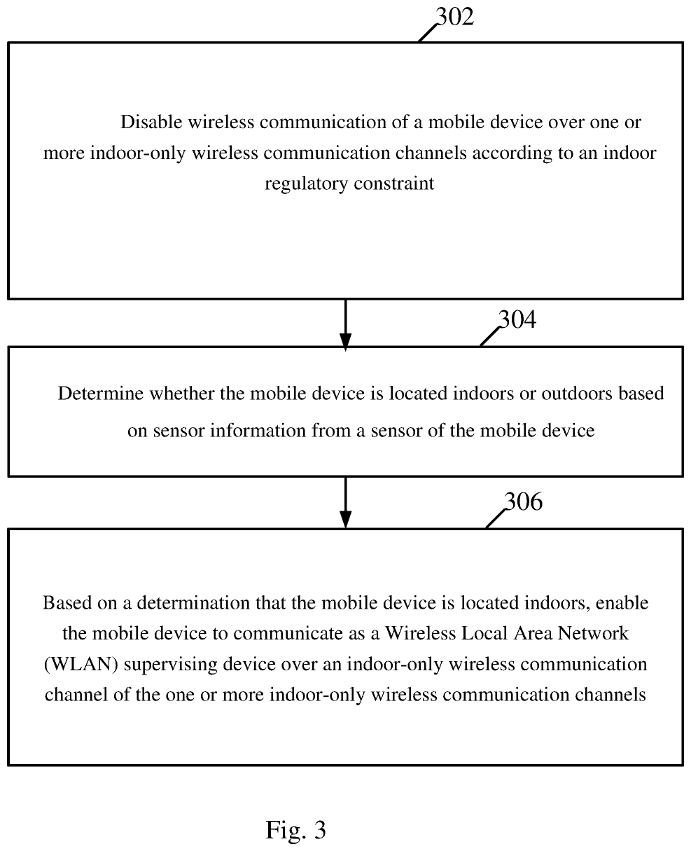

Reference is made to FIG. 3, which schematically illustrates a method of wireless communication over an indoor-only wireless communication channel, in accordance with some exemplary embodiments. For example, one or more operations of the method of FIG. 3 may be performed by one or more elements of a system, e.g., system 100 (FIG. 1), for example, one or more wireless devices, e.g., device 102 (FIG. 1), a controller, e.g., controller 124 (FIG. 1), a radio, e.g., radio 114 (FIG. 1), a receiver, e.g., receiver 116 (FIG. 1), and/or a message processor, e.g., message processor 128 (FIG. 1).

As indicated at block 302, the method may include disabling wireless communication of a mobile device over one or more indoor-only wireless communication channels according to an indoor regulatory constraint. For example, controller 124 (FIG. 1) may be configured to cause, trigger, and/or control the wireless communication station implemented by device 102 (FIG. 1) to disable the wireless communication of device 102 (FIG. 1) over the one or more indoor-only wireless communication channels according to the indoor regulatory constraint, e.g., as described above.

As indicated at block 304, the method may include determining whether the mobile device is located indoors or outdoors based on sensor information from a sensor of the mobile device. For example, controller 124 (FIG. 1) may be configured to cause, trigger, and/or control the wireless communication station implemented by device 102 (FIG. 1) to determine whether the mobile device is located indoors or outdoors based on sensor information 135 (FIG. 1) from sensors 130 (FIG. 1), e.g., as described above.

As indicated at block 306, the method may include, based on a determination that the mobile device is located indoors, enabling the mobile device to communicate as a WLAN supervising device over an indoor-only wireless communication channel of the one or more indoor-only wireless communication channels. For example, controller 124 (FIG. 1) may be configured to cause, trigger, and/or control the wireless communication station implemented by device 102 (FIG. 1) to enable device 102 (FIG. 1) to communicate a WLAN supervising device over the indoor-only wireless communication channel of the one or more indoor-only wireless communication channels, for example, based on the determination that device 102 (FIG. 1) is located indoors, e.g., as described above.

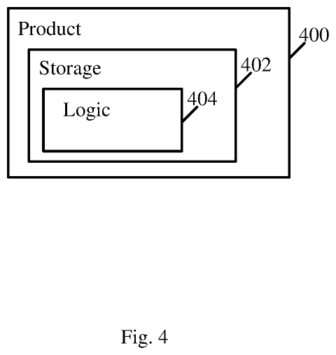

Reference is made to FIG. 4, which schematically illustrates a product of manufacture 400, in accordance with some exemplary embodiments. Product 400 may include one or more tangible computer-readable (“machine-readable”) non-transitory storage media 402, which may include computer-executable instructions, e.g., implemented by logic 404, operable to, when executed by at least one computer processor, enable the at least one computer processor to implement one or more operations at device 102 (FIG. 1), radio 114 (FIG. 1), receiver 116 (FIG. 1), transmitter 118 (FIG. 1), controller 124 (FIG. 1), and/or message processor 128 (FIG. 1), to cause device 102 (FIG. 1), radio 114 (FIG. 1), receiver 116 (FIG. 1), transmitter 118 (FIG. 1), controller 124 (FIG. 1), and/or message processor 128 (FIG. 1) to perform, trigger and/or implement one or more operations and/or functionalities, and/or to perform, trigger and/or implement one or more operations and/or functionalities described with reference to the FIGS. 1, 2, and/or 3, and/or one or more operations described herein. The phrases “non-transitory machine-readable medium” and “computer-readable non-transitory storage media” may be directed to include all computer-readable media, with the sole exception being a transitory propagating signal.

In some demonstrative embodiments, product 400 and/or machine-readable storage media 402 may include one or more types of computer-readable storage media capable of storing data, including volatile memory, non-volatile memory, removable or non-removable memory, erasable or non-erasable memory, writeable or rewriteable memory, and the like. For example, machine-readable storage media 402 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, a Solid State Drive (SSD), an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 404 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 404 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

Example 1 includes an apparatus including logic and circuitry configured to cause a mobile device to disable wireless communication of the mobile device over one or more indoor-only wireless communication channels according to an indoor regulatory constraint; determine whether the mobile device is located indoors or outdoors based on sensor information from a sensor of the mobile device; and based on a determination that the mobile device is located indoors, enable the mobile device to communicate as a Wireless Local Area Network (WLAN) supervising device over an indoor-only wireless communication channel of the one or more indoor-only wireless communication channels.

Example 2 includes the subject matter of Example 1, and optionally, wherein the sensor information comprises environment information of an environment of the mobile device.

Example 3 includes the subject matter of Example 1 or 2, and optionally, wherein the sensor information comprises ambient light information from an ambient light sensor of the mobile device.

Example 4 includes the subject matter of Example 3, and optionally, wherein the apparatus is configured to cause the mobile device to identify an ambient light spectrum based on the ambient light information, and to determine whether the mobile device is located indoors or outdoors based on the ambient light spectrum.

Example 5 includes the subject matter of Example 4, and optionally, wherein the apparatus is configured to determine that the mobile device is located outdoors based on a determination that the ambient light spectrum corresponds to natural light.

Example 6 includes the subject matter of Example 4 or 5, and optionally, wherein the apparatus is configured to determine that the mobile device is located indoors based on a determination that the ambient light spectrum corresponds to artificial light.

Example 7 includes the subject matter of any one of Examples 1-6, and optionally, wherein the apparatus is configured to, when enabling the mobile device to communicate as the WLAN supervising device over the indoor-only wireless communication channel, maintain a virtual geofence around the mobile device; and based on a detected crossing of the geofence by the mobile device, disable wireless communication of the mobile device over the one or more indoor-only wireless communication channels according to the indoor regulatory constraint.

Example 8 includes the subject matter of any one of Examples 1-7, and optionally, wherein the sensor information comprises location information from a location sensor of the mobile device.

Example 9 includes the subject matter of Example 8, and optionally, wherein the apparatus is configured to cause the mobile device to determine the indoor-only wireless communication channel based on the location information.

Example 10 includes the subject matter of any one of Examples 1-9, and optionally, wherein the apparatus is configured to cause the mobile device to determine whether the mobile device is located indoors or outdoors based on wireless communication information from one or more wireless communications over a non-indoor wireless communication channel.

Example 11 includes the subject matter of Example 10, and optionally, wherein the wireless communication information comprises at least one of channel estimation information or device information, the channel estimation information corresponding to the non-indoor wireless communication channel, the device information corresponding to one or more wireless communication devices communicating over the non-indoor wireless communication channel.

Example 12 includes the subject matter of any one of Examples 1-11, and optionally, wherein the sensor information comprises proximity information from a proximity sensor of the mobile device.

Example 13 includes the subject matter of any one of Examples 1-12, and optionally, wherein the sensor information comprises acoustic information from an acoustic sensor of the mobile device.

Example 14 includes the subject matter of any one of Examples 1-13, and optionally, wherein the WLAN supervising device comprises a software-enabled Access Point (SoftAP), or a Peer-to-Peer (P2P) Group Owner (GO).

Example 15 includes the subject matter of any one of Examples 1-14, and optionally, comprising a radio to communicate over the one or more indoor-only wireless communication channels.

Example 16 includes the subject matter of Example 15, and optionally, comprising one or more antennas connected to the radio, a memory to store data processed by the mobile device, and a processor to execute instructions of an operating system.

Example 17 includes a system of wireless communication comprising a mobile device, the mobile device comprising one or more antennas; a radio; a memory; a processor; and a controller configured to cause the mobile device to disable wireless communication of the mobile device over one or more indoor-only wireless communication channels according to an indoor regulatory constraint; determine whether the mobile device is located indoors or outdoors based on sensor information from a sensor of the mobile device; and based on a determination that the mobile device is located indoors, enable the mobile device to communicate as a Wireless Local Area Network (WLAN) supervising device over an indoor-only wireless communication channel of the one or more indoor-only wireless communication channels.

Example 18 includes the subject matter of Example 17, and optionally, wherein the sensor information comprises environment information of an environment of the mobile device.

Example 19 includes the subject matter of Example 17 or 18, and optionally, wherein the sensor information comprises ambient light information from an ambient light sensor of the mobile device.

Example 20 includes the subject matter of Example 19, and optionally, wherein the controller is configured to cause the mobile device to identify an ambient light spectrum based on the ambient light information, and to determine whether the mobile device is located indoors or outdoors based on the ambient light spectrum.

Example 21 includes the subject matter of Example 20, and optionally, wherein the controller is configured to determine that the mobile device is located outdoors based on a determination that the ambient light spectrum corresponds to natural light.

Example 22 includes the subject matter of Example 20 or 21, and optionally, wherein the controller is configured to determine that the mobile device is located indoors based on a determination that the ambient light spectrum corresponds to artificial light.

Example 23 includes the subject matter of any one of Examples 17-22, and optionally, wherein the controller is configured to, when enabling the mobile device to communicate as the WLAN supervising device over the indoor-only wireless communication channel, maintain a virtual geofence around the mobile device; and based on a detected crossing of the geofence by the mobile device, disable wireless communication of the mobile device over the one or more indoor-only wireless communication channels according to the indoor regulatory constraint.

Example 24 includes the subject matter of any one of Examples 17-23, and optionally, wherein the sensor information comprises location information from a location sensor of the mobile device.

Example 25 includes the subject matter of Example 24, and optionally, wherein the controller is configured to cause the mobile device to determine the indoor-only wireless communication channel based on the location information.

Example 26 includes the subject matter of any one of Examples 17-25, and optionally, wherein the controller is configured to cause the mobile device to determine whether the mobile device is located indoors or outdoors based on wireless communication information from one or more wireless communications over a non-indoor wireless communication channel.

Example 27 includes the subject matter of Example 26, and optionally, wherein the wireless communication information comprises at least one of channel estimation information or device information, the channel estimation information corresponding to the non-indoor wireless communication channel, the device information corresponding to one or more wireless communication devices communicating over the non-indoor wireless communication channel.

Example 28 includes the subject matter of any one of Examples 17-27, and optionally, wherein the sensor information comprises proximity information from a proximity sensor of the mobile device.

Example 29 includes the subject matter of any one of Examples 17-28, and optionally, wherein the sensor information comprises acoustic information from an acoustic sensor of the mobile device.

Example 30 includes the subject matter of any one of Examples 17-29, and optionally, wherein the WLAN supervising device comprises a software-enabled Access Point (SoftAP), or a Peer-to-Peer (P2P) Group Owner (GO).

Example 31 includes a method to be performed by a mobile device, the method comprising disabling wireless communication of the mobile device over one or more indoor-only wireless communication channels according to an indoor regulatory constraint; determining whether the mobile device is located indoors or outdoors based on sensor information from a sensor of the mobile device; and based on a determination that the mobile device is located indoors, enabling the mobile device to communicate as a Wireless Local Area Network (WLAN) supervising device over an indoor-only wireless communication channel of the one or more indoor-only wireless communication channels.

Example 32 includes the subject matter of Example 31, and optionally, wherein the sensor information comprises environment information of an environment of the mobile device.

Example 33 includes the subject matter of Example 31 or 32, and optionally, wherein the sensor information comprises ambient light information from an ambient light sensor of the mobile device.

Example 34 includes the subject matter of Example 33, and optionally, comprising identifying an ambient light spectrum based on the ambient light information, and determining whether the mobile device is located indoors or outdoors based on the ambient light spectrum.

Example 35 includes the subject matter of Example 34, and optionally, comprising determining that the mobile device is located outdoors based on a determination that the ambient light spectrum corresponds to natural light.

Example 36 includes the subject matter of Example 34 or 35, and optionally, comprising determining that the mobile device is located indoors based on a determination that the ambient light spectrum corresponds to artificial light.

Example 37 includes the subject matter of any one of Examples 31-36, and optionally, comprising, when enabling the mobile device to communicate as the WLAN supervising device over the indoor-only wireless communication channel, maintaining a virtual geofence around the mobile device; and based on a detected crossing of the geofence by the mobile device, disabling wireless communication of the mobile device over the one or more indoor-only wireless communication channels according to the indoor regulatory constraint.

Example 38 includes the subject matter of any one of Examples 31-37, and optionally, wherein the sensor information comprises location information from a location sensor of the mobile device.

Example 39 includes the subject matter of Example 38, and optionally, comprising determining the indoor-only wireless communication channel based on the location information.

Example 40 includes the subject matter of any one of Examples 31-39, and optionally, comprising determining whether the mobile device is located indoors or outdoors based on wireless communication information from one or more wireless communications over a non-indoor wireless communication channel.

Example 41 includes the subject matter of Example 40, and optionally, wherein the wireless communication information comprises at least one of channel estimation information or device information, the channel estimation information corresponding to the non-indoor wireless communication channel, the device information corresponding to one or more wireless communication devices communicating over the non-indoor wireless communication channel.

Example 42 includes the subject matter of any one of Examples 31-41, and optionally, wherein the sensor information comprises proximity information from a proximity sensor of the mobile device.

Example 43 includes the subject matter of any one of Examples 31-42, and optionally, wherein the sensor information comprises acoustic information from an acoustic sensor of the mobile device.

Example 44 includes the subject matter of any one of Examples 31-43, and optionally, wherein the WLAN supervising device comprises a software-enabled Access Point (SoftAP), or a Peer-to-Peer (P2P) Group Owner (GO).

Example 45 includes a product comprising one or more tangible computer-readable non-transitory storage media comprising computer-executable instructions operable to, when executed by at least one processor, enable the at least one processor to cause a mobile device to disable wireless communication of the mobile device over one or more indoor-only wireless communication channels according to an indoor regulatory constraint; determine whether the mobile device is located indoors or outdoors based on sensor information from a sensor of the mobile device; and based on a determination that the mobile device is located indoors, enable the mobile device to communicate as a Wireless Local Area Network (WLAN) supervising device over an indoor-only wireless communication channel of the one or more indoor-only wireless communication channels.

Example 46 includes the subject matter of Example 45, and optionally, wherein the sensor information comprises environment information of an environment of the mobile device.

Example 47 includes the subject matter of Example 45 or 46, and optionally, wherein the sensor information comprises ambient light information from an ambient light sensor of the mobile device.

Example 48 includes the subject matter of Example 47, and optionally, wherein the instructions, when executed, cause the mobile device to identify an ambient light spectrum based on the ambient light information, and to determine whether the mobile device is located indoors or outdoors based on the ambient light spectrum.

Example 49 includes the subject matter of Example 48, and optionally, wherein the instructions, when executed, cause the mobile device to determine that the mobile device is located outdoors based on a determination that the ambient light spectrum corresponds to natural light.

Example 50 includes the subject matter of Example 48 or 49, and optionally, wherein the instructions, when executed, cause the mobile device to determine that the mobile device is located indoors based on a determination that the ambient light spectrum corresponds to artificial light.

Example 51 includes the subject matter of any one of Examples 45-50, and optionally, wherein the instructions, when executed, cause the mobile device to, when enabling the mobile device to communicate as the WLAN supervising device over the indoor-only wireless communication channel, maintain a virtual geofence around the mobile device; and based on a detected crossing of the geofence by the mobile device, disable wireless communication of the mobile device over the one or more indoor-only wireless communication channels according to the indoor regulatory constraint.

Example 52 includes the subject matter of any one of Examples 45-51, and optionally, wherein the sensor information comprises location information from a location sensor of the mobile device.

Example 53 includes the subject matter of Example 52, and optionally, wherein the instructions, when executed, cause the mobile device to determine the indoor-only wireless communication channel based on the location information.

Example 54 includes the subject matter of any one of Examples 45-53, and optionally, wherein the instructions, when executed, cause the mobile device to determine whether the mobile device is located indoors or outdoors based on wireless communication information from one or more wireless communications over a non-indoor wireless communication channel.

Example 55 includes the subject matter of Example 54, and optionally, wherein the wireless communication information comprises at least one of channel estimation information or device information, the channel estimation information corresponding to the non-indoor wireless communication channel, the device information corresponding to one or more wireless communication devices communicating over the non-indoor wireless communication channel.

Example 56 includes the subject matter of any one of Examples 45-55, and optionally, wherein the sensor information comprises proximity information from a proximity sensor of the mobile device.

Example 57 includes the subject matter of any one of Examples 45-56, and optionally, wherein the sensor information comprises acoustic information from an acoustic sensor of the mobile device.

Example 58 includes the subject matter of any one of Examples 45-57, and optionally, wherein the WLAN supervising device comprises a software-enabled Access Point (SoftAP), or a Peer-to-Peer (P2P) Group Owner (GO).

Example 59 includes an apparatus of wireless communication by a mobile device, the apparatus comprising means for disabling wireless communication of the mobile device over one or more indoor-only wireless communication channels according to an indoor regulatory constraint; means for determining whether the mobile device is located indoors or outdoors based on sensor information from a sensor of the mobile device; and means for, based on a determination that the mobile device is located indoors, enabling the mobile device to communicate as a Wireless Local Area Network (WLAN) supervising device over an indoor-only wireless communication channel of the one or more indoor-only wireless communication channels.

Example 60 includes the subject matter of Example 59, and optionally, wherein the sensor information comprises environment information of an environment of the mobile device.

Example 61 includes the subject matter of Example 59 or 60, and optionally, wherein the sensor information comprises ambient light information from an ambient light sensor of the mobile device.

Example 62 includes the subject matter of Example 61, and optionally, comprising means for identifying an ambient light spectrum based on the ambient light information, and determining whether the mobile device is located indoors or outdoors based on the ambient light spectrum.

Example 63 includes the subject matter of Example 62, and optionally, comprising means for determining that the mobile device is located outdoors based on a determination that the ambient light spectrum corresponds to natural light.

Example 64 includes the subject matter of Example 62 or 63, and optionally, comprising means for determining that the mobile device is located indoors based on a determination that the ambient light spectrum corresponds to artificial light.

Example 65 includes the subject matter of any one of Examples 59-64, and optionally, comprising means for, when enabling the mobile device to communicate as the WLAN supervising device over the indoor-only wireless communication channel, maintaining a virtual geofence around the mobile device; and based on a detected crossing of the geofence by the mobile device, disabling wireless communication of the mobile device over the one or more indoor-only wireless communication channels according to the indoor regulatory constraint.

Example 66 includes the subject matter of any one of Examples 59-65, and optionally, wherein the sensor information comprises location information from a location sensor of the mobile device.

Example 67 includes the subject matter of Example 66, and optionally, comprising means for determining the indoor-only wireless communication channel based on the location information.

Example 68 includes the subject matter of any one of Examples 59-67, and optionally, comprising means for determining whether the mobile device is located indoors or outdoors based on wireless communication information from one or more wireless communications over a non-indoor wireless communication channel.

Example 69 includes the subject matter of Example 68, and optionally, wherein the wireless communication information comprises at least one of channel estimation information or device information, the channel estimation information corresponding to the non-indoor wireless communication channel, the device information corresponding to one or more wireless communication devices communicating over the non-indoor wireless communication channel.

Example 70 includes the subject matter of any one of Examples 59-69, and optionally, wherein the sensor information comprises proximity information from a proximity sensor of the mobile device.

Example 71 includes the subject matter of any one of Examples 59-70, and optionally, wherein the sensor information comprises acoustic information from an acoustic sensor of the mobile device.

Example 72 includes the subject matter of any one of Examples 59-71, and optionally, wherein the WLAN supervising device comprises a software-enabled Access Point (SoftAP), or a Peer-to-Peer (P2P) Group Owner (GO).

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1. An apparatus including logic and circuitry configured to cause a mobile device to:
disable wireless communication of the mobile device over one or more indoor-only wireless communication channels according to an indoor regulatory constraint;
determine whether the mobile device is located indoors or outdoors based on sensor information from a sensor of the mobile device; and
based on whether the mobile device is determined to be located indoors or outdoors, select whether to allow or not to allow, respectively, the mobile device to operate as a Wireless Local Area Network (WLAN) supervising device to form a WLAN for communication with one or more wireless communication stations over an indoor-only wireless communication channel of the one or more indoor-only wireless communication channels, and to control communication in the WLAN.

2. The apparatus of claim 1, wherein the sensor information comprises environment information of an environment of the mobile device.

3. The apparatus of claim 1, wherein the sensor information comprises ambient light information from an ambient light sensor of the mobile device.

4. The apparatus of claim 3 configured to cause the mobile device to identify an ambient light spectrum based on the ambient light information, and to determine whether the mobile device is located indoors or outdoors based on the ambient light spectrum.

5. The apparatus of claim 4 configured to determine that the mobile device is located outdoors based on a determination that the ambient light spectrum corresponds to natural light.

6. The apparatus of claim 4 configured to determine that the mobile device is located indoors based on a determination that the ambient light spectrum corresponds to artificial light.

7. The apparatus of claim 1 configured to, when selecting to allow the mobile device to operate as the WLAN supervising device over the indoor-only wireless communication channel:
maintain a virtual geofence around the mobile device; and
based on a detected crossing of the geofence by the mobile device, disable wireless communication of the mobile device over the one or more indoor-only wireless communication channels according to the indoor regulatory constraint.

8. The apparatus of claim 1, wherein the sensor information comprises location information from a location sensor of the mobile device.

9. The apparatus of claim 8 configured to cause the mobile device to determine the indoor-only wireless communication channel based on the location information.

10. The apparatus of claim 1 configured to cause the mobile device to determine whether the mobile device is located indoors or outdoors based on wireless communication information from one or more wireless communications over a non-indoor wireless communication channel.

11. The apparatus of claim 10, wherein the wireless communication information comprises at least one of channel estimation information or device information, the channel estimation information corresponding to the non-indoor wireless communication channel, the device information corresponding to one or more wireless communication devices communicating over the non-indoor wireless communication channel.

12. The apparatus of claim 1, wherein the sensor information comprises proximity information from a proximity sensor of the mobile device.

13. The apparatus of claim 1, wherein the sensor information comprises acoustic information from an acoustic sensor of the mobile device.

14. The apparatus of claim 1, wherein the WLAN supervising device comprises a software-enabled Access Point (SoftAP), or a Peer-to-Peer (P2P) Group Owner (GO).

15. The apparatus of claim 1 comprising a radio to communicate over the one or more indoor-only wireless communication channels.

16. The apparatus of claim 15 comprising one or more antennas connected to the radio, a memory to store data processed by the mobile device, and a processor to execute instructions of an operating system.

17. A product comprising one or more tangible computer-readable non-transitory storage media comprising computer-executable instructions operable to, when executed by at least one processor, enable the at least one processor to cause a mobile device to:
disable wireless communication of the mobile device over one or more indoor-only wireless communication channels according to an indoor regulatory constraint;
determine whether the mobile device is located indoors or outdoors based on sensor information from a sensor of the mobile device; and
based on whether the mobile device is determined to be located indoors or outdoors, select to allow or not to allow, respectively, the mobile device to operate as a Wireless Local Area Network (WLAN) supervising device to form a WLAN for communication with one or more wireless communication stations over an indoor-only wireless communication channel of the one or more indoor-only wireless communication channels, and to control communication in the WLAN.

18. The product of claim 17, wherein the sensor information comprises environment information of an environment of the mobile device.

19. The product of claim 17, wherein the sensor information comprises ambient light information from an ambient light sensor of the mobile device.

20. The product of claim 19, wherein the instructions, when executed, cause the mobile device to identify an ambient light spectrum based on the ambient light information, and to determine whether the mobile device is located indoors or outdoors based on the ambient light spectrum.

21. The product of claim 17, wherein the instructions, when executed, cause the mobile device to, when selecting to allow the mobile device to operate as the WLAN supervising device over the indoor-only wireless communication channel:
maintain a virtual geofence around the mobile device; and
based on a detected crossing of the geofence by the mobile device, disable wireless communication of the mobile device over the one or more indoor-only wireless communication channels according to the indoor regulatory constraint.

22. The product of claim 17, wherein the instructions, when executed, cause the mobile device to determine whether the mobile device is located indoors or outdoors based on wireless communication information from one or more wireless communications over a non-indoor wireless communication channel.

23. An apparatus of wireless communication by a mobile device, the apparatus comprising:
means for disabling wireless communication of the mobile device over one or more indoor-only wireless communication channels according to an indoor regulatory constraint;
means for determining whether the mobile device is located indoors or outdoors based on sensor information from a sensor of the mobile device; and
means for, based on whether the mobile device is determined to be located indoors or outdoors, selecting whether or not to allow the mobile device to communicate as a Wireless Local Area Network (WLAN) supervising device to form a WLAN for communication with one or more wireless communication stations over an indoor-only wireless communication channel of the one or more indoor-only wireless communication channels, and to control communication in the WLAN, wherein selecting whether or not to allow the mobile device to communicate as the WLAN supervising device comprises selecting to allow the mobile device to communicate as the WLAN supervising device based on a determination that the mobile device is determined to be located indoors, and selecting not to allow the mobile device to communicate as the WLAN supervising device based on a determination that the mobile device is determined to be located outdoors.

24. The apparatus of claim 23, wherein the sensor information comprises environment information of an environment of the mobile device.

25. The apparatus of claim 23 comprising means for, when selecting to allow the mobile device to operate as the WLAN supervising device over the indoor-only wireless communication channel:
maintaining a virtual geofence around the mobile device; and
based on a detected crossing of the geofence by the mobile device, disabling wireless communication of the mobile device over the one or more indoor-only wireless communication channels according to the indoor regulatory constraint.
